(19) United States
(12) Patent Application Publication
(10) Pub. No.: US 2021/0306611 A1
(43) Pub. Date: Sep. 30, 2021

(54) Multiview Image Capture and Display System

(71) Applicant: Ian Amadeo Brinkley, New York, NY (US)

(72) Inventor: Ian Amadeo Brinkley, New York, NY (US)

(21) Appl. No.: 16/831,233

(22) Filed: Mar. 26, 2020

(51) Int. Cl. H04N 13/243; H04N 5/225; H04N 5/235

(52) U.S. Cl. CPC H04N 13/243; H04N 5/2354; H04N 5/2256

(57) ABSTRACT

A method and apparatus for creating light patterns capable of forming three-dimensional, multi-angular, focus-variable images and videos. The production of such images and videos is achieved through the controlled emission of beams of collimated light from many small, point-like sources, each consisting of many collimated light beam emitting elements oriented in many different directions. Also, a method and apparatus for capturing the optical information within a physical situation requisite to the reproduction of three-dimensional, multi-angular, focus-variable images and videos of physical objects. This is achieved by recording optical information of multiple light rays arriving at a point-like location from many different directions by a hemispherical node consisting of many light-travel-direction sensitive photo-detectors oriented in many different directions.

### CROSS-REFERENCE RELATED APPLICATIONS

Not Applicable

### STATEMENT REGARDING FEDERALLY SPONSORED RESEARCH OR DEVELOPMENT

Not Applicable

### BACKGROUND OF THE INVENTION

Today, the use of electronic image display screens is widespread. Due to the design of the display screens currently in use, it is generally not possible to project from these screens different images in different directions. In the few extant models of display screens which can project different images from their surfaces in different directions, major limitations exist: The number of directions in which different images can be projected from extant models is often very small (for instance, 2), and it is sometimes the case that the viewer of the screen must be located at one specific distance from the screen in order to clearly perceive the different projected images which emanate from the screen at different angles. Further, some of the extant designs of multi-view screens are such as to preclude the production of video images on those screens, being capable only of static multi-directional image production. And, while some models of multi-view screens are capable of producing video, they can only do so in one color. A successful design of an electronic image display system capable of 1.) projecting many different images consisting of many different colors in many different directions, 2.) projecting these images in a way which allows a viewer of these projected images to occupy a wide range of positions relative to the screen, and 3.) projecting different sets of images at different angles over time as is required for video production, would represent a significant improvement on the current state of the art of electronic image display screens, and of extant multi-direction image producing screen designs. Included in this document is such a design. The name of this design is “Multiview Display”.

Today, the use of cameras is widespread. Due to the design of the cameras currently in use, and the lack of effective multi-angular image displays, it is not generally possible to use cameras, as currently designed, in a way which can lead to the satisfactory production of multi-angle images of physical objects or scenes. A multi-angle image is a set of different images projected from a single area of a screen at different angles such that the pattern of light rays constituting these images mimics the pattern of light rays which have been projected from a real, physical three dimensional object or scene at different angles. Currently, in instances in which multi-angle images of a real object or scene are desired to be produced for an observer (as in the case of flight simulations for pilots in training), multiple cameras must be used to collect multiple images of the physical object from different angles. Because there are no multi-angle image displays currently available to reproduce these captured images effectively, the images from each camera must be appropriately projected onto a curved reflecting surface which surrounds the viewer. The number of reproducible images of the object from different angles is therefore severely limited by the number of cameras used, as well as by other factors such as the possible arrangements of projectors around the viewer. A successful design of a device capable of registering the optical information of a physical object or scene from many different angles would eliminate the need for multiple cameras to be used in the production of multi-angle images. A design for such a device is included in this document, it is named “Multi-Angle Photo-Detector”.

Combined with a Multiview Display, the Multi-Angle Photo-Detector enables the reproduction of the visual experience of physical objects, through the creation of multi-angle images, with greater efficacy than current methods render possible.

The process by which many different colors and intensities of light are simultaneously projected at many different angles from a single point-like source will be referred to in this document as “anisotropic point emission”. The ability to control anisotropic point emission is the basis for the controlled production of a multitude of visual effects which are unattainable, or only very ineffectually attainable, without that ability. Some of these effects include, but are not limited to: 1.) The creation of images on a screen which are perceived by the viewer as three dimensional without the need for, or the limitations of, stereoscopic methods currently in use. An example of the limitations of 3-dimensional image production by means of stereoscopic methods is the way in which the viewer is unable to choose on what part of the displayed image scene they are to perceive a focused image. (The Multiview Display then also represents an improvement in the art of three-dimensional image production) 2.) The creation of multi-angle images of objects. Multi-angle images of objects enable a viewer to perceive different viewpoint images of a single depicted object as the viewing angle to the projecting screen on which the object is depicted is altered. As an example, consider a multi-angle image of a human face depicted on a screen: The front of the face might be made to be projected perpendicularly from the screen while images of the left or right sides of the face are projected at different viewing angles deviating from perpendicular. As an observer moved around the screen, the illusion of moving around a real, stationary human face would be produced. If the viewer observed the screen with a line of sight perpendicular to the screen, the viewer would see an image of the front of the face on the screen. If the viewer took one step to the left, the viewer would see an image of the right side of the face on the screen. If the viewer took one step to the right, the viewer would see an image of the left side of the face on the screen. This is very different from the way in which images are viewed on almost all currently available image display screens: If an image of the front of a human face is being projected by a currently state of the art screen, a viewer of the screen will always see that image of the front of the face at every angle from which that viewer views the screen (though there will be horizontal and/or vertical compression of that image as the viewer deviates from a perpendicular line of sight from the screen). 3.) The ability to enable different people to see different images or watch different videos on the same screen while viewing the screen from different angles.

The degree to which these effects can be produced to a satisfactory extent depends upon the precision with which anisotropic point emission can be realized and controlled. The Multiview Display presents a means by which anisotropic point emission can be realized and controlled to an extent not currently possible, Thus, the Multiview Display represents a means by which currently unproduceable visual effects dependent upon the control of anisotropic point emission can be produced.

### BRIEF SUMMARY OF THE INVENTION

The Multiview Image Capture and Display System consists of two essential components: 1.) The Multiview Display, and 2.) The Multi-Angle Photo-Detector

Similar to electronic image display monitors currently in use, the Multiview Display is comprised of a screen which is affixed to a housing in which the hardware necessary to the functioning of the screen is enclosed. Also similar to electronic displays in use today, the Multiview Display projects light from its screen to create images for viewing. Most image producing screens today rely on pixels to produce the light which forms the images projected from those screens. But, a given pixel emanates the same color and intensity of light in all directions, and thus, the creation of multi-angle images, (or of any other effect dependent upon the control of anisotropic point emission), is not possible with pixel based screens. The Multiview Display replaces the pixel with an element called the “Light Node”. Light Nodes fill the entire surface of the Multiview Display, just as pixels fill the surfaces of current electronic display screens. The Light Node is a (generally very small) fixture which contains many light beam emitting components called “Beam Elements”. Each Beam Element produces a straight beam of collimated or coherent monochromatic light. These Beam Elements are arranged in a fashion so as to allow for a large number of different light rays to be directed in many different directions relative to the fixture to which they are attached. The color of the light emitted from each Beam Element in the Light Node can be varied through the spectrum of visible colors, and can be varied in brightness. Similar to the way in which the color and brightness of each of the many individual pixels in current electronic image display screens is electronically regulated to suit the image production needs of the user, each of the many Beam Elements in each Light Node filling the screen of the Multiview Display is electronically regulated to suit the image production needs of the user. With the Multiview Display, however, the angle relative to the screen of the light beam emitted by each Beam Element must be taken into account when determining how the emission patterns of the Beam Elements are to be regulated.

The size, number, and density of the Light Nodes and Beam Elements can be modified to suit the intended uses of the screen based on considerations such as resolution requirements. The density of Beam Elements contained in each Light Node will determine the number of distinct images which can be created within a particular range of viewing angles. The greater the density of Beam Elements on each Light Node, the greater the number of distinct images are possible for a given viewing angle range, and the more satisfactorily will the effects depending upon the control of anisotropic point emission be produced. The smaller each individual Light Node, the higher the resolution of the images produced. If desired, all of the Beam Elements in each individual Light Node can be made to emit the same color and intensity, thereby rendering the Multiview Display functionally equivalent to a pixel based electronic display monitor in which the light from each pixel is of the same color and intensity in every direction of emission.

The Multi-Angle Photo-Detector is a smooth surface. This surface is attached to an information processing and storage component located either at some distance from the surface, or within a housing to which the surface might be affixed. The front surface of the Multi-Angle Photo-Detector is covered with small “Photo-Detector Nodes” which are attached to it. The Photo-Detector Node contains many photo-detectors. Each of these photo-detectors is designed such that each detects only light which reaches it from one direction. These are called “Directional Photo-Detectors”. The Directional Photo-Detectors will be arranged in the Photo-Detector Node in such a way as to enable them to detect and register light arriving at the Photo-Detector Node from the surrounding environment from many different angles. The Photo-Detector Nodes, then, play a similar, but inverse role to the Light Nodes which cover the Multiview Display: whereas the Multiview Display emits straight light beams of varying color and intensity in many different directions at each small, point-like Light Node on its surface, the Multi-Angle Photo-Detector absorbs and registers the light rays arriving from many different directions at each of the small, point-like Photo-Detector Nodes which cover its surface. The information gathered by the Directional Photo-Detectors is then transmitted to an information processing and storage unit. As the light arriving at the Multi-Angle Photo-Detector does not need to be focused, no lens in involved in its design.

The Multiview Image Capture and Display System is the system which utilizes both the Multiview Display and the Multi-Angle Photo-Detector to reproduce multi-angle images of physical objects. In this system, the information collected by the Multi-Angle Photo-Detector is transmitted to the Multiview Display. In this process, the color and intensity of each ray of light detected by each Directional Photo-Detector in each of the Photo-Detector Nodes of the Multi-Angle Photo-Detector is appropriately assigned to be emitted by a corresponding Beam Element in a Multiview Display. Hence, not just one image is captured by a camera and reproduced by a screen, but a whole range of images is captured and reproduced by a single screen.

### BRIEF DESCRIPTION OF THE SEVERAL VIEWS OF THE DRAWING

FIG. 1 Perspective view of the Light Node (100). Embedded in the shell of the Light Node are Beam Elements (103). Beams of light (104) are emitted from each Beam Element. The light node is attached to the surface of the Multiview Display (102).

FIG. 2 Cross sectional view of Light Node emitting two beams of light (104), with adjacent Light Node (100) (detail not shown in adjacent Light Node). The hemispherical shell of the Light Node (101) is attached to the front surface of the Multiview Display (102). The shell of the Light Node is not essential to the Light Node, but represents only one means by which many different Beam Elements can be appropriately arranged over a large number of angles relative to a single point like location to enable anisotropic point emission. In this embodiment, the Beam Elements (103) extend into the volume enclosed by the shell of the Light Node. The Beam Elements are not embedded in the shell of the Light Node below a certain angle from the surface of the Multiview Display. This angle is the smallest angle relative to the surface of the Multiview Display that a Beam Element can have before the light ray emitted from it intersects the Light Node adjacent to it. The bight Nodes are each connected to an image control system by individual wires (106) which bundle into a cable leading to the image control system.

FIG. 3 Perspective wedge cross sectional view of the Light Node. Beam Elements (103), emitted beams of light (104), hemispherical shell of the Light Node (101), the front surface of the Multiview Display (102) and the wires connecting to the image control system (106) are shown.

FIG. 4 Perspective view of flat rectangular embodiment of the Multiview Display. The surface of the Multiview Display (102) is affixed to a housing (107) in which the hardware necessary to the functioning of the Multiview Display is enclosed. A magnified circular portion (A) of the image shows the presence of Light Nodes (100) closely packed on the surface of Multiview Display.

FIG. 5 Curved embodiment of Multiview Display: Housing component (107). Front surface (102).

FIG. 6. Side view of flat rectangular Multiview Display variant. (107 is the housing component of the Multiview Display. (102) is the front surface of the Multiview Display. Different colors and intensities of light (104) are emitted from each Light Node on the surface of the Multiview Display. Viewers at locations (A), (B) and (C) will each see different images on the screen of the Multiview Display.

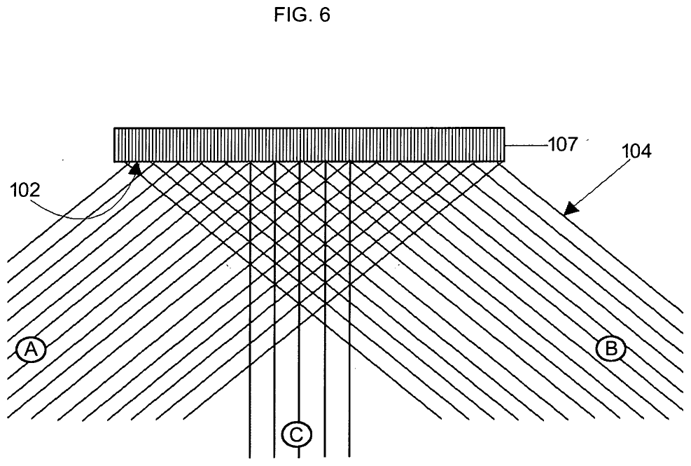

FIG. 7 Perspective view of Photo-Detector Node (200) with Directional Photo-Detectors (203). Rays of light (204) are registered by the Directional Photo-Detectors. The Photo-Detector Node is attached to the surface of the Multi-Angle Photo-Detector (202).

FIG. 8 Cross sectional view of Photo-Detector Node with an adjacent Photo-Detector Node (200) (detail not shown in adjacent Photo-Detector Node). The hemispherical shell of the Photo-Detector Node (201) is attached to the front surface of the Multi-Angle Photo-Detector (202). Directional Photo-Detectors (203) extend into the volume enclosed by the shell of the Photo-Detector Node in which they are embedded. The Directional Photo-Detectors are each connected to an information storage system by individual wires (206) which bundle into a cable leading to the information storage system.

FIG. 9 Perspective wedge cross sectional view of the Photo-Detector Node: Surface of Multi-Angle Photo-Detector (202), Directional Photo-Detectors (203), arriving rays of light (204), wires connecting each Directional Photodetector to an information storage system (206).

FIG. 10 Perspective of flat rectangular embodiment of the Multi-Angle Photo-Detector. A magnified circular portion (A) of the image shows the presence of Photo-Detector Nodes (200) closely packed on the surface of the Multi-Angle Photo-Detector (202). In this embodiment, the front surface of the Multi-Angle Photo-Detector is affixed to a housing (207) in which information storage hardware, and other hardware, is enclosed.

FIG. 11 Curved embodiment of Multi-Angle Photo-Detector. Housing component (207), Front surface (202).

FIG. 12 Multi-Angle Photo-Detector (400) with housing component (207) and front surface (202), and Multiview Display (300), with housing component (107) and front surface (102), of identical size and shape, back to back, illustrating the process of optical event registration and reproduction.

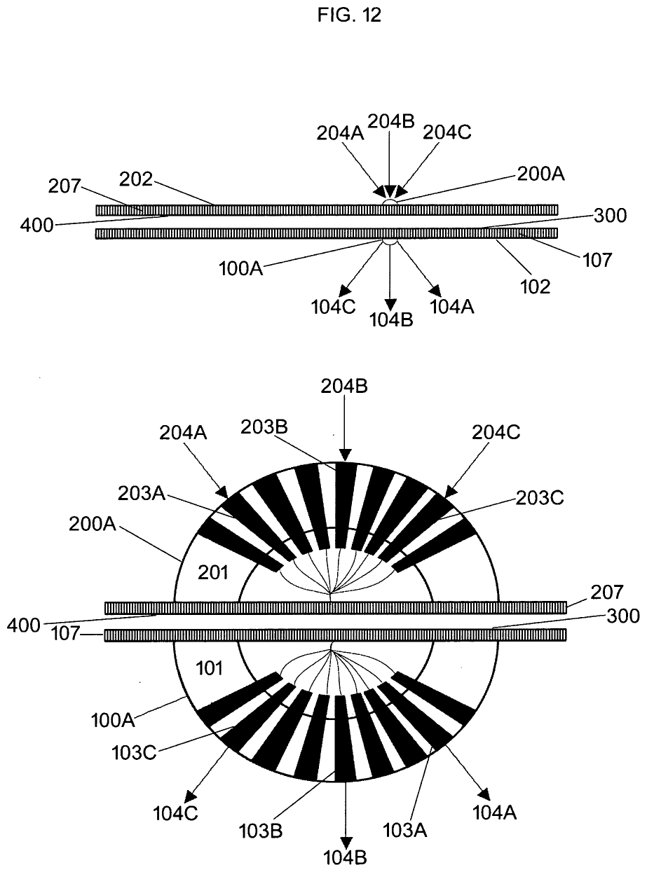

The Multi-Angle Photo-Detector and the Multiview Display can each be any out of a large number of possible sizes and shapes. The Multi-Angle Photo-Detector does not need to be the same size or shape as the Multiview Display for which it is capturing optical information; but, the relationship between the functioning of the Multi-Angle Photo-Detector and the Multiview Display is more easily demonstrated thorough an illustration of a situation in which they are of equal size and shape. The following illustration also takes the number, density and orientation of the Light Nodes and Beam Elements in the Multiview Display to be the same as that of the Photo-Detector Nodes and their Directional Photo-Detectors in the Multi-Angle Photo-Detector.

The Multiview Display (300) and the Multi-Angle Photo-Detector (400) are placed back to back. Light arriving at the front surface of the Multi-Angle Photo-Detector (204A, 204B, 204C) arrives at all angles. Each of the Directional Photo-Detectors on the Photo-Detector Nodes on the surface of the Multi-Angle Photo-Detector (400) will register the color and intensity of the light which arrives at it which is perpendicular to the hemispherical shell of the Photo-Detector Node at the point at which the Directional Photo-Detector is embedded. If light ray A (204A) arrives at Photo-Detector Node A (200A) at a certain angle relative to (202), and is registered by Directional Photo-Detector A (203A), then the color and intensity of this ray is recorded for future image reproduction use. This information is then be processed and transmitted to the system which controls the light emission patterns of the Beam Elements in each of the Light Nodes in the Multiview Display (300). If a one-to-one replication of the light captured by the Multi-Angle Photo-Detector is desired to be produced by the Multiview Display, then Light Node A (100A), which is opposite to Photo-Detector Node A (200A), will be selected for the emission of a beam of light of the same color and intensity as that registered by Directional Photo-Detector A. This light will be emitted out of Beam Element A (103A) which has an orientation corresponding to Directional Photo-Detector 1 such that the beam of light (104A) emitted from Beam Element 1 is also of the same direction as that absorbed by Directional Photo-Detector 1. Light ray (204A) and light beam (104A) will have the same color, intensity, orientation and approximate position as each other. The same relation holds for light ray (204B) along with light beam (104B), and for light ray (204C) along with beam (104C). As this replicative process will be performed for thousands, or millions of beams registered by the Multi-Angle Photo-Detector and reproduced by the Multiview Display, the Multiview Display will effectively recreate the optical conditions present at the time and location at which the Multi-Angle Photo-Detector was in operation.

### DETAILED DESCRIPTION OF THE INVENTION

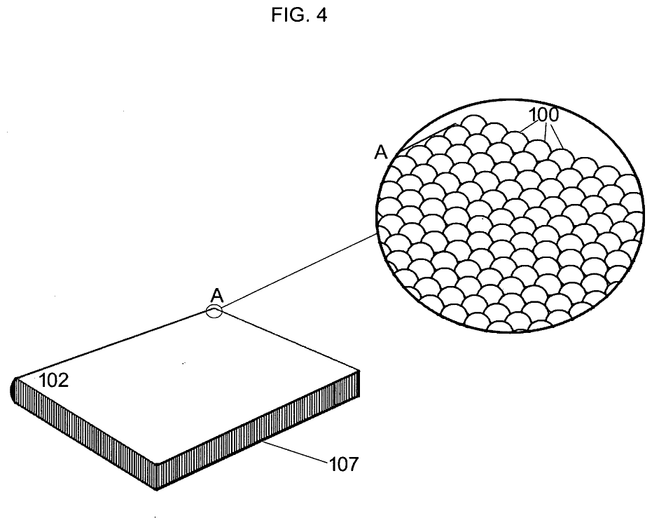

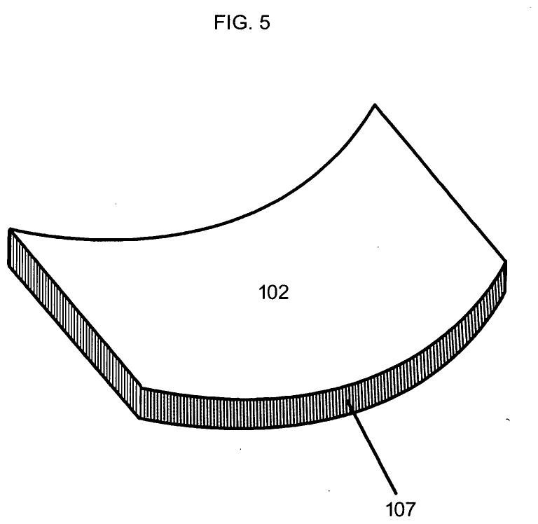

The Multiview Display (300) (FIGS. 4 and 5) consists of a body with a smooth front surface (102) affixed to a housing (107) in which the hardware necessary to the functioning of the device is contained. The surface can be either flat (FIG. 4), or it can be curved (FIG. 5.). In the embodiment described here, the surface is flat.

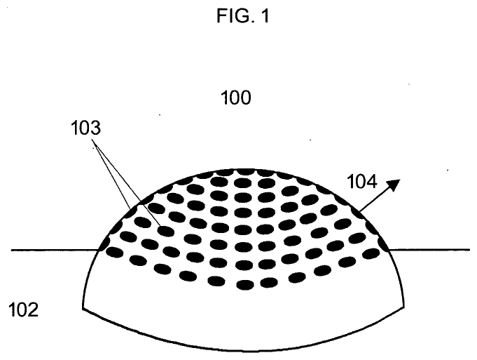

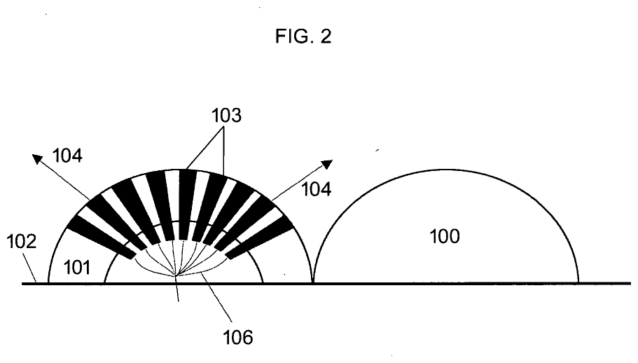

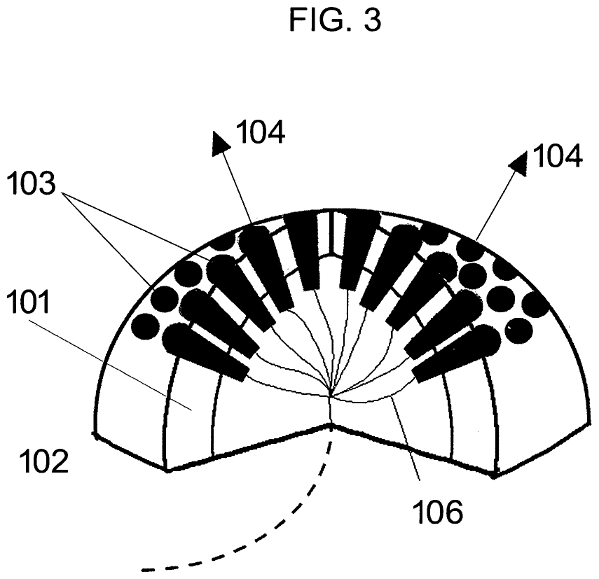

To the front surface of the Multiview Display are attached many small, fixtures called Light Nodes (100) (FIGS. 1, 2 and 3).

In the embodiment described here, each Light Node consists of a hemispherical shell (101) which is affixed to the front surface of the Multiview Display (102), and a number of Beam Elements (103). To improve image quality, these hemispherical Light Nodes are arranged on the surface in a hexagonal circle-packing pattern to minimize the distance between them. The Light Nodes cover the part of the front surface of the Multiview Display which is desired to be made functional for image production.

Many Beam Elements are embedded in the shell of each Light Node. The Beam Elements produce colliminal or coherent monochromatic light of variable color and intensity (104). The Beam Element is embedded in the shell of the Light Node such that the direction of the beam of light which the Beam Element emits (104) is outward from the Light Node. In this embodiment, this beam (104) is perpendicular to the tangent plane of the hemispherical shell of the Light Node at the point at which the Beam Element is embedded. The smallest angle relative to the surface of the Multiview Display at which a beam of light emitted from a Beam Element is relevant to image production depends upon the shape and arrangement of the Light Nodes. In this embodiment, there is an angle (105) which is the minimum angle relative to (102) in which a beam can be emitted outward from and perpendicular to (101) without intersecting the surface of an adjacent Light Node.

Each Beam Element is attached to a wire (106) which connects to the image control system which is located in the housing component (107) of the Multiview Display. Information sent to the image control system in the Multiview Display is delivered from outside of the Multiview Display system. This information is then processed and transformed into signals which are delivered, via (106), to the individual Beam Elements. These signals determine the color and intensity of light which each Beam Element emits and the time at which this emission will take place. For the determination of the regulation of the pattern by which each Beam Element will be made to emit light of a certain color and intensity at a certain time, not only the position of the Light Node in which each Beam Element is embedded will be a factor, but also the orientation of each Beam Element relative to the screen.

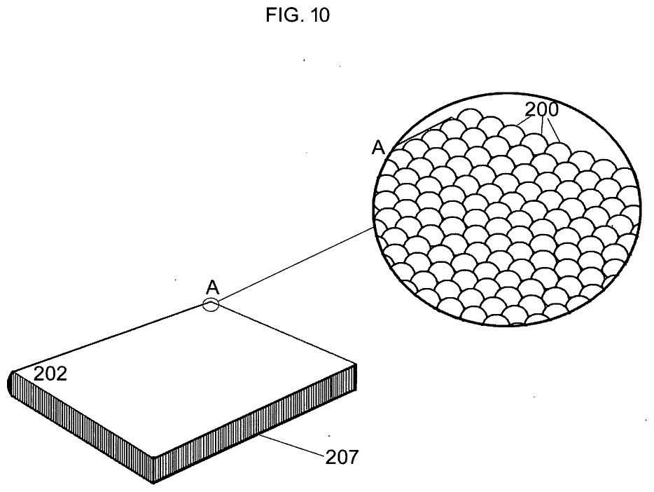

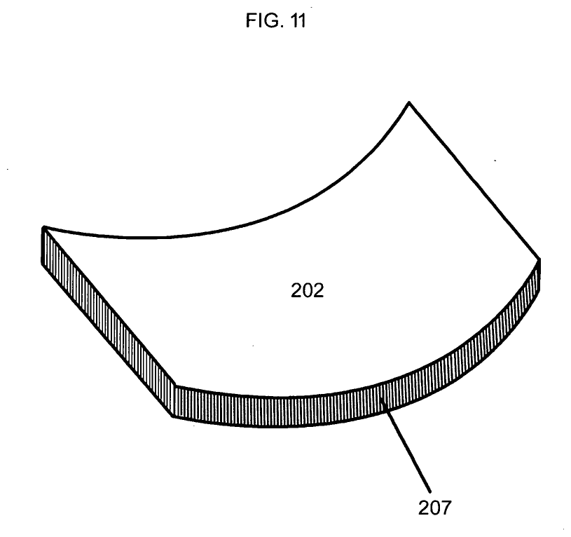

The Multi-Angle Photo-Detector (400) (FIGS. 10 and 11) consists of a body with a smooth front surface (202), which can be affixed to a housing (207) in which hardware such as information storage systems are contained. The front surface can be either flat (FIG. 10), or it can be curved (FIG. 11). In the embodiment described here, the screen is flat.

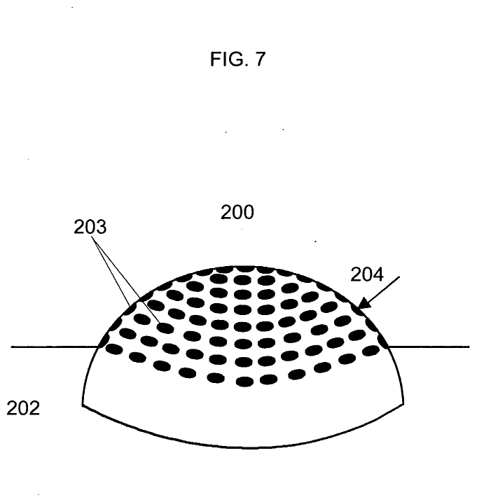

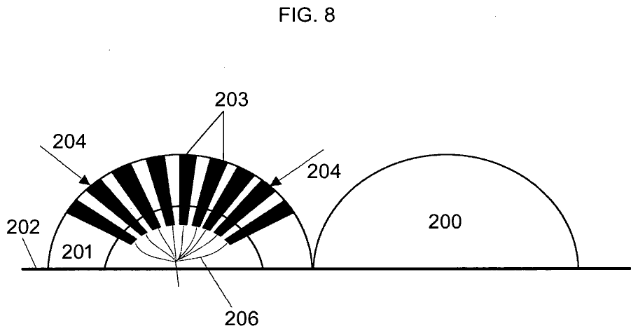

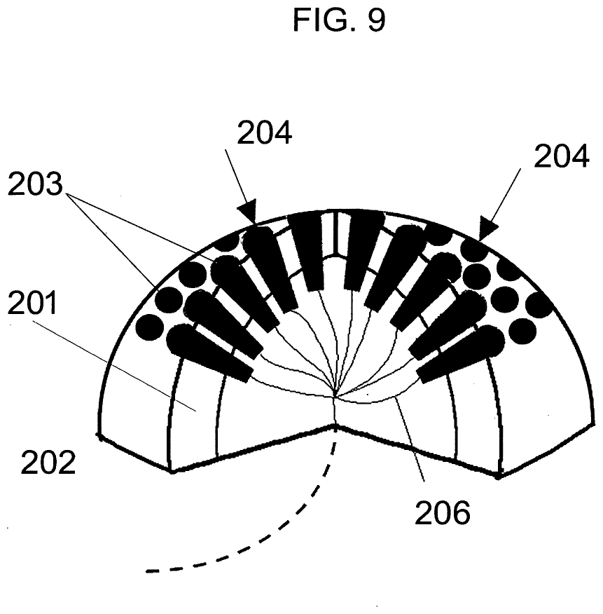

To the front surface (202) of the Multi-Angle Photo-Detector are attached many small fixtures called Photo-Detector Nodes (200) (FIGS. 7, 8, and 9).

In the embodiment described here, each Photo-Detector Node consist of a hemispherical shell (201), which is affixed to the front surface of the Multi-Angle Photo-Detector (202), and a number of Directional Photo-Detectors (203).

The Photo-Detector Nodes cover the entire image capturing part of the front surface of the Multi-Angle Photo-Detector. These hemispherical Photo-Detector Nodes are arranged on (202) in a hexagonal circle-packing pattern to minimize the distance between them. The Directional Photo-Detectors are embedded in the shell of the Photo-Detector Node. These Directional Photo-Detectors are situated in the shell of the Photo-Detector Node such that the Directional Photo-Detectors can detect light (204) which arrives at the Photo-Detector Node from the surrounding environment. Each Directional Photo-Detector is designed and situated so as to only detect light which arrives at the surface of the Photo-Detector Node perpendicular to the tangent plane of (201) at the point at which each Directional Photo-Detector is situated. The Directional Photo-Detectors register the color and intensity information of only light which arrives perpendicularly at the Photo-Detector Node (204). Each Directional Photo-Detector is attached to a wire (206) which connects to an information processing and storage system.

The smallest angle relative to the surface of the Multi-Angle Photo-Detector (400) at which a beam of light from the surrounding environment can arrive perpendicularly at each Photo-Detector Node depends upon the shape and arrangement of the Photo-Detector Nodes. In this embodiment, there is an angle (205) which is the maximum angle relative to (202) in which an incoming beam of light can reach a Photo-Detector Node without being blocked by an adjacent Photo-Detector Node.

The information collected by the Multi-Angle Photo-Detector is then communicated to the image control system of the Multiview Display, which, in turn, regulates the light production patterns of the Beam Elements in the Multiview Display to reproduce the light originally registered by the Multi-Angle Photo-Detector. The reproduction of this light by the Multiview Display will result in a multi-angle image or video which is perceived as three dimensional by viewers.

1-5. (canceled)

6: A method of producing multiple light rays simultaneously, wherein said light rays originate in a single screen and are collectively constituted so as to establish simultaneously a multiplicity of physical possibilities for the visual perception of three-dimensional, focused images, wherein each of said images is different from each other, wherein which of said images is actually perceived is determined by 1.) the angular position of the perceiver of said images with respect to said screen, and 2.) the state of the physiologic accommodation of the eye(s) of said perceiver at the time of perception of said images, and wherein the production of said light rays can be modified over time such that the physical possibility for the perception of a sequence of said images through time so as to constitute a motion picture is established; said method consisting of: an electronically controlled, simultaneous emission of multiple collimated light-beams, wherein said emission is non-time-varying for the production of static images or is time-varying for the production of motion pictures, wherein said light-beams are of variable or single color and variable or single intensity, and wherein said light beams are directed in multiple directions away from individual hemispherical units, wherein said units are compactly arranged adjacent to each other so as to comprise a screen, wherein each of said units consists of a plurality of collimated light-beam producing elements which produce said light-beams, and wherein said light-beam producing elements are connected to and controlled by electronic systems.

7: An apparatus embodying the method of claim 6, consisting of a plurality of hemispherical units compactly arranged adjacent to each other so as to comprise a screen, wherein said units consist of a plurality of collimated light-beam producing elements, wherein said light-beam producing elements are oriented in multiple directions and simultaneously connected to and controlled by electronic systems.

8: A method of capturing the optical information within a physical situation requisite to the reproduction of the light rays present within said physical situation by the light-ray producing method of claim 6, wherein the images or motion pictures formed by said light rays are of physical objects within said physical situation; the method consisting of: the detection and registration of the color, and/or intensity, and the direction of travel of light which arrives at individual hemispherical units, wherein said units are compactly arranged adjacent to each other so as to comprise a screen, wherein each of said units consists of a plurality of photo-detectors, wherein each of said photo-detectors is capable of measuring the color, and/or intensity, and unique direction of travel of each light ray which it detects, wherein said photo-detectors are arranged and oriented within said units so as to detect light that arrives from multiple unique directions at said units, and wherein each of said photo-detectors is connected to an electronic information storage, processing, and control unit.

9: An apparatus embodying claim 8, consisting of multiple hemispherical units compactly arranged adjacent to each other so as to comprise a screen, wherein each of said units consists of a plurality of photo-detectors, wherein each of said photo-detectors is capable of measuring the color, and/or intensity, and unique direction of travel of each light ray which it detects, wherein said photo-detectors are oriented in multiple directions with respect to said units and are each connected to an electronic information storage, processing and control unit.
